(19) United States
(12) Patent Application Publication
(10) Pub. No.: US 2014/0012494 A1
(43) Pub. Date: Jan. 9, 2014

(54) COLLABORATIVE GPS TRACKING

(71) Applicants: Gary D. Cudak, Creedmoor, NC (US); Christopher J. Hardee, Raleigh, NC (US); Randall C. Humes, Raleigh, NC (US); Ruthie D. Lyle, Durham, NC (US); Adam Roberts, Moncure, NC (US)

(72) Inventors: Gary D. Cudak, Creedmoor, NC (US); Christopher J. Hardee, Raleigh, NC (US); Randall C. Humes, Raleigh, NC (US); Ruthie D. Lyle, Durham, NC (US); Adam Roberts, Moncure, NC (US)

(73) Assignee: INTERNATIONAL BUSINESS MACHINES CORPORATION, Armonk, NY (US)

(21) Appl. No.: 13/542,700

(22) Filed: Jul. 6, 2012

(51) Int. Cl. G01C 21/28; G01C 21/34

(52) U.S. Cl. 701/412; 701/482; 701/465

(57) ABSTRACT

A collaborative GPS navigation system and method enables nearby vehicles to share and compare planned route for improving navigation. While navigating along a planned route, a navigation device on a first vehicle may detect a specific, slower-moving second vehicle. The navigation device on the first vehicle may obtain the planned route of the second vehicle, compare the two planned routes to identify a shared route segment, and dynamically revise the planned route and route metrics according to the comparison.

### BACKGROUND

1. Field of the Invention

The present invention relates to vehicle navigation using a global positioning system (GPS).

2. Background of the Related Art

A GPS-based navigation system is commonly used to guide a user to a destination. A GPS-based navigation system receives signals from an array of satellites that are part of the GPS. Using these signals, the navigation system may identify its location, which is representative of the location of a vehicle or a user. GPS-based navigation systems are installed on many vehicles. However, portable handheld navigation systems are also now common. Many modern smartphones include a built-in GPS antenna and navigation software, which allows the user to determine his or her location regardless of whether or not the user is in a vehicle. Common functions of a navigation system include obtaining a speed and direction of travel, and guiding a user to a destination. Audiovisual feedback is provided by the navigation system to communicate instructions to a user for reaching the destination.

### BRIEF SUMMARY

A navigation system and method are disclosed. In one embodiment, a method involves obtaining a planned route to a destination for a first vehicle and for navigating the first vehicle to that destination. While the first vehicle is moving along the planned route, a second vehicle is identified that is within a threshold distance ahead of the first vehicle along the planned route of the first vehicle and has a speed of less than an expected speed of the first vehicle at that location. A planned route is obtained that is being followed by the second vehicle. The planned routes of the first and second vehicles are compared to identify a shared segment of the planned routes. A delay of the first vehicle to the destination is computed as a function of the speed of the second vehicle along the shared segment. Revised route information is computed on the basis of the delay. The revised route information may include a revised route metric, such as a travel delay or updated ETA, or even a revised route. The revised route information is automatically communicated to an input/output device on the first vehicle or at a location remote from the first vehicle. The method may be implemented by a device or a system of devices according to program code embodied on a non-volatile storage medium.

### BRIEF DESCRIPTION OF THE SEVERAL VIEWS OF THE DRAWINGS

FIG. 1 is a diagram of a collaborative GPS-based navigation system.

FIG. 2 is a schematic diagram of one of the navigation devices of FIG. 1.

FIG. 3 is a flowchart outlining an embodiment of a navigation method

### DETAILED DESCRIPTION

A collaborative GPS navigation system and method is disclosed that enables planned routes of navigation devices on detected nearby vehicles to be shared and compared for improving navigation. Each navigation device in the system may initially obtain a planned route for its vehicle in a conventional manner, such as by planning a specific route to a destination. In planning a route, a navigation device may initially take into account such factors as posted speed limits, current construction zones, historical traffic flow patterns, and known route conditions. While navigating along the planned route, the navigation device on a first vehicle may identify a specific, slower-moving second vehicle, which could not have been known by conventional means such as historical traffic flow patterns or even by real-time traffic data. The navigation device on the first vehicle may alert the slower-moving second vehicle. The navigation device on the first vehicle may also request and obtain the planned route of the second vehicle, compare the two planned routes to identify a shared route segment, and dynamically revise the planned route and route metrics accordingly. The ability of the disclosed navigation system and method to identify a specific vehicle that may impede its progress along a planned route and to obtain and compare the planned route of the nearby vehicle to its own planned route may provide greater navigational accuracy and improved route metrics.

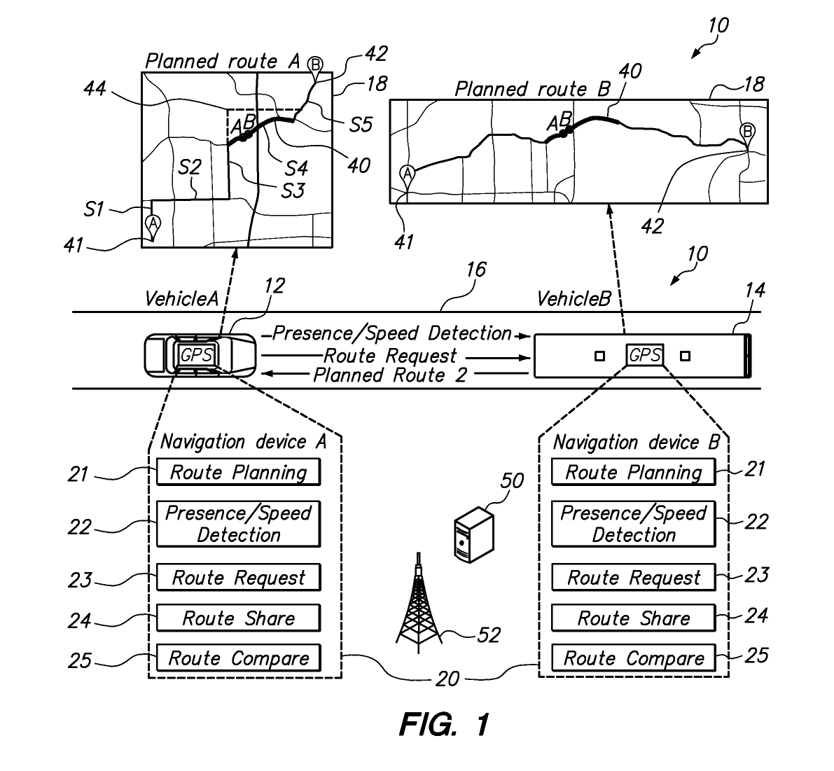

FIG. 1 is a diagram of an embodiment of a collaborative GPS-based navigation system 10. FIG. 1 illustrates a scenario wherein two vehicles 12, 14 in close proximity are travelling down a road 16, each guided by a respective GPS-enabled navigation device 20 identified in the figure as Navigation Device A and Navigation Device B. By way of example, the first vehicle (“Vehicle A”) is illustrated as a passenger car 12 and the second vehicle (“Vehicle B”) is illustrated as a bus 14 travelling along a road 16 just in front of the first vehicle 12. However, any type of vehicle with a navigation device may participate in the system 10. Each navigation device 20 is installed or otherwise carried in the respective vehicle 12, 14 so that Navigation Device A moves with the first vehicle 12 and Navigation Device B moves with the second vehicle 14. Each navigation device 20 may comprise, for example, a portable GPS unit or a smartphone with a GPS software application, or a GPS navigation system built-in to the respective vehicle 12, 14. The navigation devices 20 are not required to be identical, but may include a subset of features that enable collaboration between the two navigation devices 20. For example, each navigation device 20 may include the same set of logic modules such as a route planning module 21, a vehicle proximity/speed detector module 22, a route requestor module 23, a route sharing module 24, and a route comparison module 25. The components of a representative navigation device 20 are discussed more extensively below. When in close proximity, the navigation devices 20 may selectively communicate as described further below. The navigation devices 20 may communicate directly with one another, such as over a near field communication (NFC) channel or infrared link, or over a wireless cellular network 52. Peer-to-peer communication between the navigation devices 20 may be facilitated by a database residing on the remote server 50.

The route planning module 21 is used to obtain a planned route for the respective vehicle 12, 14. Each vehicle 12, 14 may follow separately-planned routes 18 from respective starting points 41 to respective destinations 42. The planned routes 18 are depicted in FIG. 1 as they might be displayed on screens of the respective navigation devices 20. For ease of reference, the planned route 18 provided by Navigation Device A is labeled Planned Route A, and the planned route 18 provided by Navigation Device B is labeled Planned Route B. The route planning modules 21 of each device 20 may initially generate the planned routes 18 in a conventional manner, which may include inputting the destination, determining a starting location for each vehicle 12, 14, and computing a specific route from the starting location to the destination. The planned routes may also initially be generated according to an optimization criteria, such as to minimize expected travel distance or travel time based on an initial set of assumptions. These assumptions may include known information at the time of planning the routes, such as posted speed limits, current construction zones, historical traffic flow patterns, and driver habits. Advancements have also been made in ETA calculations in GPS units that include the individual driver's history, traffic, accidents, weather and a number of other factors. Each planned route 18 includes a continuous path from the starting point 41 to the destination 42. The planned route 18 also includes expected speeds at different locations along the planned route 18. In Planned Route A, for example, the expected speeds are labeled from S1 to S5. The expected speeds may be based on the known information used to plan the route. For instance, the expected speeds S1-S5 at each location may be computed as the posted speed at that location, as optionally reduced by other factors such as expected traffic congestion or construction zones. The expected speeds may be used to determine an estimated time of arrival (ETA) at the destination.

The destinations and routes of the two vehicles 12, 14 are initially planned irrespective of one another, such that each navigation device 20 is unaware of the route planned by the other. While travelling along their planned routes, Navigation Device A tracks the location of the first vehicle 12 relative to Planned Route A, while Navigation Device B separately tracks the location of the second vehicle 14 relative to Planned Route B. The car 12 and bus 14 in this example are presently driving down the same road 16 with the second vehicle 14 slightly ahead of the first vehicle 12. The locations of the two vehicles 12, 14 are represented as dots labeled A and B in the Planned Routes A and B of FIG. 1.

The car 12 and bus 14 are in proximity of one another, with the bus 14 travelling at a slower speed than an expected speed of the car 12 at that location. Proximity may be determined as a threshold distance away. The threshold may be as low as, for example, one or two car lengths between the first and second vehicles 12, 14. Proximity may alternatively be defined to include a situation where there are no intervening vehicles between vehicles 12 and 14, such as if the bus 14 is directly in front of the car 12 blocking a lane designated for faster drivers (e.g. a far left lane). When in proximity, the navigation devices 20 on the nearby first and second vehicles 12, 14 may establish a communication link. The navigation devices 20 may communicate directly with one another for navigational collaboration, such as using a near field communication (NFC) channel like Bluetooth® or infrared signals to transmit and receive a communication signal directly between the two navigation devices 20. The navigation devices 20 may alternatively communicate over a cellular network 52. Route information such as the planned routes 18 themselves, the current locations of the two vehicles 12, 14, or route metrics such as an ETA of each vehicle 12, 14 may be selectively shared over the communication link. Alternatively, the route information may be obtained from a shared database residing on the remote server 50.

The proximity/speed detection module 22 on Navigation Device A is used to detect the proximity and speed of the second vehicle 14, and to determine whether the speed of the second vehicle 14 is significantly less than the expected speed of the first vehicle 12. The proximity and/or speed between the two vehicles 12, 14 may be detected in a variety of ways, such as by transmitting an optical or radio signal from the first vehicle 12 and analyzing a reflection from the second vehicle 14 (e.g. radar). The proximity may also be detected by the presence of a near field communication channel (e.g. Bluetooth®), which typically only broadcasts a short distance away from the source. The proximity and speed of the second vehicle 14 may also be determined by obtaining the GPS location data of its navigation device 20 and communicating that data back to the first vehicle 12, such as over an NFC channel or cellular data network 52, where the GPS coordinates of the two vehicles may be compared to identify if they are within a threshold distance. Another option is to have the user/driver of the first vehicle 12 manually input (e.g. by pressing a button) the presence of the second vehicle 14 impeding his or her progress, in which case the proximity is determined by the user visually and the speed of the second vehicle 14 may be inferred from the speed of the first vehicle 12.

In response to detecting the second vehicle 14 in close proximity to the first vehicle 12, Navigation Device A may initially alert the second vehicle 14 that it is impeding the flow of traffic. To avoid an overly obtrusive alert system, the alert may be generated only when one or more applicable thresholds are reached. For instance, a time and speed threshold may be selected whereby Navigation Device A alerts Navigation Device B only if the second vehicle 14 is travelling more than a threshold amount below the expected speed S4 of the first vehicle 12 at that location and/or is travelling slower than the expected speed S4 of the first vehicle 12 for more than a predetermined time threshold. As a practical example, this will avoid having an alert generated at the second vehicle 14 in response to every minor deceleration or during brief stops. Navigation Device B may also communicate to Navigation Device A that vehicle 14 is a special type of vehicle such as a bus that is required to make frequent stops, to exempt the second vehicle 14 from receiving an alert.

The route request module 23 on Navigation Device A may request to obtain Planned Route B for the purpose of determining how the second vehicle 14 travelling along the shared route segment 40 may affect the progress of the first vehicle 12 along its Planned Route A. In response to the request, the Route Share module 24 of Navigation Device B communicates Planned Route B to Navigation Device A over the applicable communication channel. This information may be communicated directly from Navigation Device B to an input/output device on the first vehicle 12 such as the Navigation Device A over the cellular network 52 or NFC, for instance. Alternatively, Navigation Device A may indirectly obtain the requested information from the shared database on the remote server 50. For example, the planned routes 18 may be computed by and/or stored on the remote server 50 and the navigation devices 20 may dynamically communicate their GPS coordinates to the remote server 50.

As a privacy consideration, the amount and type of information communicated regarding a planned route may be restricted. For example, sufficient information regarding Planned Route B may be provided to Navigation Device A to compute the shared route segment 40 without explicitly providing personal information about the second vehicle 14 or its driver, and without providing the final destination 42 of the second vehicle 14. This avoids any driver being able to determine the destination of another driver by simply driving up close to the other driver.

The route compare module 25 may be used to compare Planned Routes A and B to determine a shared segment 40. The shared route segment 40 is highlighted in bolded line type. Although each vehicle has a different starting point 41 and a different destination 42, the shared segment 40 is common to both of Planned Routes A and B. The route planning module 21 may then be used to automatically compute revised route and travel metrics for the first vehicle 12 based on the shared route segment 40 and the speed of the second vehicle 14 impeding the first vehicle 12. First, an expected delay of the first vehicle 12 in reaching its destination 42 may be computed based on the speed of the second vehicle 14 and the length of the shared segment 40. A revised ETA for the first vehicle 12 in reaching its destination 42 may also be determined. The speed of the second vehicle 14 used in this calculation may be an instantaneous or average speed of the second vehicle 14. The instantaneous or average speeds of the second vehicle 14 may be directly observed and measured from the first vehicle 12, either using Navigation Device A, the car's instrument cluster (e.g. a digital speedometer), or a combination thereof. Alternatively, these speeds may be obtained from GPS speed and/or position data tracked by Navigation Device B. The speed and/or position data of the second vehicle 14 may be communicated directly from Navigation Device B to Navigation Device A, such as using an NFC channel or cellular connection between the two navigation devices 20. Alternatively, the speed and/or position data of the second vehicle 14 may be obtained by Navigation Device A from the remote server 50. The revised route information for the first vehicle 12 may include route metrics, such as a delay or an updated ETA, or a revised route for the first vehicle if one is computed on the basis of the second vehicle 14 impeding the first vehicle 12. The revised route information may be automatically communicated to an input/output device at a location remote from the first vehicle 12, such as to the smartphone of a person waiting for the driver to arrive at the destination 42.

The Planned Route A may also be automatically revised to navigate the first vehicle around the second vehicle to a position ahead of the second vehicle along the planned route. An example of a revised route segment 44 is shown, which is intended to route the first vehicle 12 around the second vehicle 14. To ensure that the first vehicle 12 avoids the path of the second vehicle 14, the revised route may be computed not only to navigate the first vehicle to a position ahead of the second vehicle, but also to cause the first vehicle 12 to avoid the remainder of the shared segment 40 entirely—e.g., in the example of FIG. 1, the first vehicle 12 will be routed along a path for the remainder of the trip that the second vehicle 14 is not expected to travel down assuming it continues to follow Planned Route B. The revised route segment 44 rejoins the original Planned Route A at a location beyond the shared route segment 40. The revised route segment 44 may be communicated to the first vehicle 12 for guiding the driver along revised route segment 44. Revised route metrics such as a revised ETA may also be communicated to the driver of the first vehicle 12 or to the electronic device at a remote location, such as the smartphone of someone awaiting the driver of the first vehicle 12.

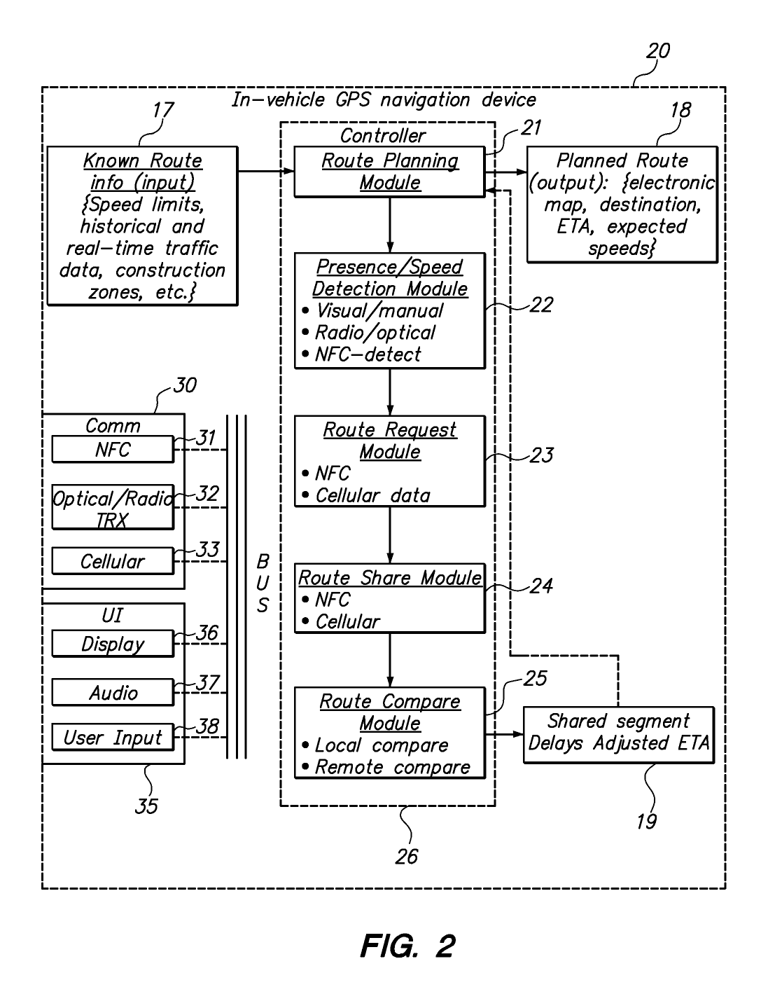

FIG. 2 is a schematic diagram of one of the navigation devices 20 of FIG. 1 according to one embodiment. The navigation device 20 includes a controller 26, a communications section 30, and a user interface (UI) 35. The controller includes the various logic modules 21-25 introduced in FIG. 1 governing the control of the navigation device 20 and its collaboration with other navigation devices. The logic modules may consist of hardware and/or software components residing directly on the navigation device 20 or on a remote server. The communication section 30 includes communications hardware and associated control logic for communicating with other navigation devices. Optional components of the communications section 30 include a near field communication (NFC) module 31, an optical and/or radio transceiver (TRX) module 32, and a cellular interface module 33. The UI 35 includes a display component 36, an audio component 37, and a user input component 38. The display component 36 is for displaying route information, such as an electronic map representing a planned route, and/or route metrics such as an ETA. The audio component 37 may provide audio feedback to assist with navigation, such as to provide voice-guided directions and to sound alerts generated by other navigation devices on nearby vehicles. The user input section 38 allows the user of the navigation device 20 to provide information that may be used in route planning. The user input section 38 may include a keyboard for entering text input and a microphone with speech recognition software for entering audio input. The controller 26 is in electronic communication with the communication section 30 and the UI 35 over a bus 39.

Referring to the controller 26, the logic modules 21-25 are arranged in the diagram from top to bottom in the order they may be invoked in planning a route and navigating along the planned route. However, the logic modules 21-25 are not limited to being invoked in this particular order, and may be selectively invoked on an as-needed basis. Initially, the route planning module 21 may be invoked by a user to generate a planned route. Known route conditions 17 may be supplied as an input to the route planning module 21. The known route information may be supplied primarily by a navigation service that maintains a continually updated global map data. The route info 17 may be provided on physical media, such as a DVD, or dynamically provided to the navigation device 20 over a data connection, such as a mobile Internet connection. The known route conditions 17 may include detailed maps, including distances and speed limits. The known route conditions 17 may also include historical traffic data, real-time traffic data such as provided by traffic cams, and construction zones, all of which may affect route planning and expected route metrics.

To plan a route, the route planning module 21 receives a selected destination, which may be input by a user at the UI 35. The route planning module 21 may obtain a starting location from user input or from the current GPS coordinates sensed by the navigation device 20. The route planning module 21 processes the known route conditions 17 to obtain a planned route 18, and to obtain route metrics such as expected speeds at different locations along the planned route 18 and an ETA. A planned route 18 may be separately obtained for each of a plurality of different vehicles. While each vehicle moves along the planned route 18, the navigation device 20 tracks its position along the planned route and compares the tracked movement of the navigation device with the expected movement according to the planned route 18.

As described with reference to FIG. 1, the proximity/speed detection module 22 on a first vehicle may be invoked to detect the presence of a nearby second vehicle ahead of the first vehicle, and to determine whether a speed of the second vehicle is less than an expected speed of the first vehicle. The presence of the second vehicle may be visually detected by the user/driver and manually input via the UI 36. Alternatively, the presence of the second vehicle may be automatically detected using radio or optical signals transmitted by the transceiver module 32. The radio or optical signals may be generated by the transceiver module 32 at the first vehicle, and a reflection of the signals may be received by the transceiver module 32 to determine the presence and/or distance away of the second vehicle. A delay between transmitting and receiving the reflected signals may be interpreted to determine the distance and/or speed of the second vehicle (e.g. radar or laser distance and speed detection). Alternatively, the transceiver module 32 on a navigation device on the second vehicle may receive the radio or optical signals transmitted by the transceiver module 32 on the first vehicle and respond by generating an appropriate radio or optical response signal, such as to complete a handshake between the navigation devices 20 of the first and second vehicles. Yet another way the proximity/speed detection module 22 may detect proximity and/or speed is using the NFC module 31. NFC channels such as Bluetooth® are typically short-range, so it may be assumed that a detected NFC transmission having predefined characteristics (e.g. an agreed homing signal or handshake frequency) is from a nearby vehicle navigation device. In response to detecting the NFC signal, the NFC module 31 may initiate or establish an NFC link with the navigation device of the second vehicle. The NFC link between the navigation devices 20 of the two vehicles may then be used to communicate position and speed data between the two navigation devices 20.

The route request module 23 of the first vehicle may next be invoked. The route request module 23 may generate a request for the planned route 18 of the second vehicle over an available communication link, such as an NFC link, radio or optical link, or cellular data link. An initial request is made to confirm that the second vehicle also has a navigation device having the components in the diagram of FIG. 2 and is actively following a planned route. If so, the route share module 24 of the second vehicle may then respond by allowing the first vehicle to obtain the planned route of the second vehicle that is currently impeding the first vehicle. The navigation device 20 of the second vehicle may allow the planned route to be passively obtained, such as by granting permissions to the navigation device 20 of the first vehicle from a remote server. The navigation device 20 of the second vehicle may instead affirmatively provide the planned route to the first vehicle, such as by transmitting the planned route to the first vehicle using the NFC module 31, transceiver 32, cellular interface module 33, or other available communication channel.

Upon receiving the planned route of the second vehicle, the route compare module 25 of the first vehicle may compare its own planned route 18 (of the first vehicle) to the planned route of the second vehicle to obtain revised route information 19. The route compare module 25 may identify a shared segment of the two planned routes and generate an updated route and updated route metrics. The route compare module may invoke the route planning module 21 to revise the planned route 18 and update the route metrics such as an ETA. The shared segment and the speed of the second vehicle both affect the route metrics of the first vehicle. For example, the difference between the actual speed of the second vehicle and the expected speed of the first vehicle, and the length of the shared route segment, all affect the delay in the first vehicle reaching its destination. Such a delay may be used to compute a revised (typically, later) ETA for the first vehicle. The revised route information 19 may be fed back to the route planning module 21 for the purpose of revising the planned route 18.

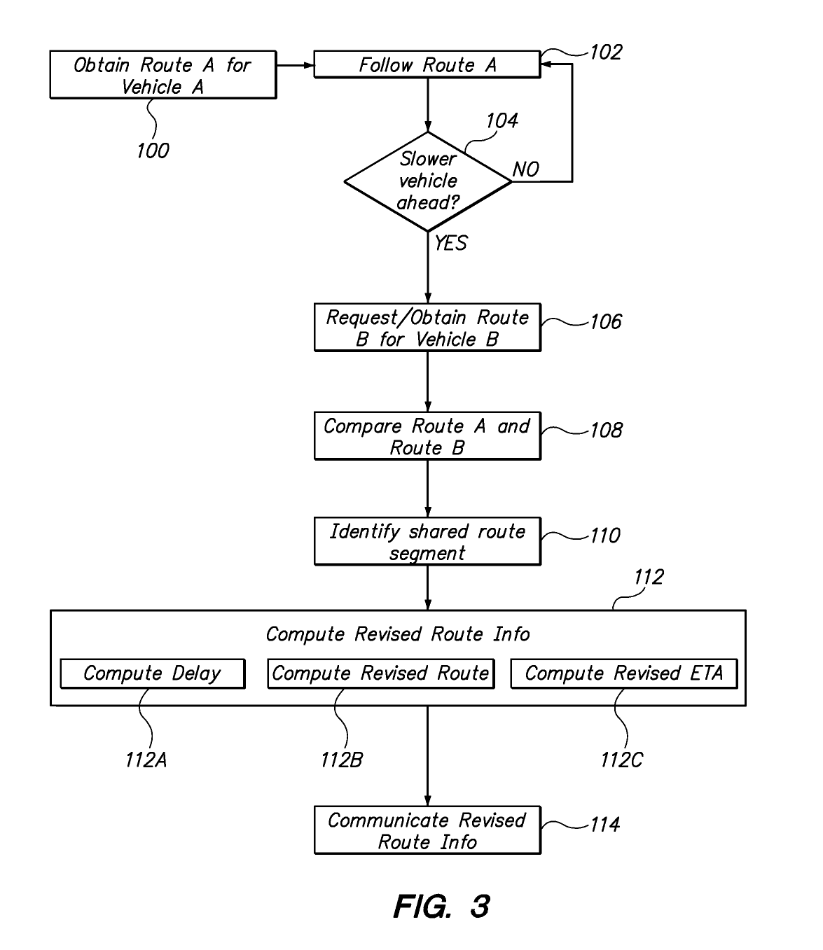

FIG. 3 is a flowchart outlining an embodiment of a navigation method. The method is implemented by a device or system of devices according to machine-readable program code. The steps of the method may incorporate the elements and considerations discussed with reference to FIGS. 1 and 2. Step 100 is to obtain a planned route (Route A) for a first vehicle (Vehicle A). Conditional step 102 is to follow the route planned in step 100, which may involve tracking the changing GPS coordinates of the first vehicle along the planned route. Conditional step 104 is to identify whether a slower vehicle (Vehicle B) is ahead of and in close proximity to the first vehicle. If a slower-moving vehicle is nearby but is not impeding the first vehicle, or if the nearby vehicle is ahead of but travelling at least the expected speed of the first vehicle, then the first vehicle may simply continue to follow the planned route per step 102. However, if the first vehicle is being impeded by the second vehicle then step 106 is invoked to request and obtain the planned route of the slower moving second vehicle (Route B). In step 108, the two routes are compared. In step 110, a shared route segment is identified. Step 112 involves computing revised route information for the first vehicle based on the shared route segment identified in step 110. Three examples include computing a delay per step 112A, computing a revised route per step 112B, and computing a revised ETA per step 112C. In step 114, the revised route information is communicated to the first vehicle and optionally to another location remote from the first vehicle.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer program product including computer usable program code embodied on a computer usable storage medium, the computer program product comprising:
computer usable program code for obtaining a first planned route to a destination for a first vehicle and for navigating the first vehicle to the destination;
computer usable program code for identifying a second vehicle within a threshold distance ahead of the first vehicle along the planned route of the first vehicle, the second vehicle having a speed of less than an expected speed of the first vehicle at that location along the first planned route;
computer usable program code for obtaining a second planned route being followed by the second vehicle and comparing the first and second planned routes to identify a shared segment of the first and second planned routes;
computer usable program code for computing a delay of the first vehicle to the destination as a function of the speed of the second vehicle along the shared segment and computing revised route information for the first vehicle on the basis of the delay; and
computer usable program code for automatically communicating the revised route information to an input/output device in the first vehicle or at a location remote from the first vehicle.

2. The computer program product of claim 1, further comprising:
computer usable program code for estimating expected speeds at different locations along the first planned route based on current conditions about the first planned route; and
computer usable program code for computing the delay of the first vehicle to the destination as a function of both the speed of the second vehicle and the expected speed of the first vehicle along the shared segment.

3. The computer program product of claim 1, further comprising:
computer usable program code for computing a revised route to navigate the first vehicle around the second vehicle to a position ahead of the second vehicle along the first planned route in response to identifying the shared segment of the first and second planned routes; and
computer usable program code for communicating the revised route to the first vehicle.

4. The computer program product of claim 3, further comprising:
computer usable program code for computing a revised route segment that rejoins the first planned route being followed by the first vehicle at a location beyond the shared segment.

5. The computer program product of claim 1, further comprising:
computer usable program code for automatically identifying one or both of the proximity and speed of the second vehicle directly by generating an optical or radio frequency transmission from the first vehicle and analyzing reflections of the optical or radio frequency transmission from the second vehicle back to the first vehicle.

6. The computer program product of claim 1, further comprising:
computer usable program code for communicating an optical or radio frequency transmission from the second vehicle to the first vehicle indicating one or both of the proximity and the speed of the second vehicle.

7. The computer program product of claim 6, further comprising:
computer usable program code for generating the optical or radio frequency transmission from the second vehicle to the first vehicle in response to an electronic request from the first vehicle to the second vehicle.

8. The computer program product of claim 1, further comprising:
computer usable program code for receiving manual user input identifying the proximity of the second vehicle ahead of the first vehicle;
computer usable program code for determining the speed of the second vehicle in response to the manual user input; and
computer usable program code for generating a request at the first vehicle for obtaining the second planned route in response to determining that the speed of the second vehicle is less than the expected speed of the first vehicle as determined prior to identifying the proximity of the second vehicle.

9. The computer program product of claim 1, wherein the computer usable program code for identifying a second vehicle ahead of the first vehicle along the first planned route further comprises:
computer usable program code for tracking the location of the first vehicle relative to the first planned route;
computer usable program code for tracking the location of the second vehicle relative to the second planned route; and
computer usable program code for comparing the location of the second vehicle relative to the location of the first vehicle to determine that the second vehicle is ahead of the first vehicle.

10. The computer program product of claim 9, further comprising:
computer usable program code for transmitting the location of the first vehicle and the location of the second vehicle to a remote server from the respective first and second vehicles;
computer usable program code for comparing the locations of the first and second vehicles at the remote server to determine that the second vehicle is ahead of the first vehicle; and
computer usable program code for communicating the proximity of the second vehicle ahead of the first vehicle from the remote server back to the first vehicle.

11. The computer program product of claim 1, further comprising:
computer usable program code for communicating a route request from the first vehicle to the second vehicle for the second planned route; and
computer usable program code for communicating the second planned route from the second vehicle back to the first vehicle in response to the route request.

12. The computer program product of claim 11, further comprising:
computer usable program code for communicating the route request and the planned route of the second vehicle over a near field communication channel.

13. The computer program product of claim 11, further comprising:
computer usable program code for communicating the route request from the first vehicle to the second vehicle over a cellular data network.

14. The computer program product of claim 13, further comprising:
computer usable program code for communicating the second planned route to the first vehicle over the cellular data network.

15. The computer program product of claim 1, further comprising:
computer usable program code for communicating an electronic alert signal to the second vehicle in response to identifying the proximity of the second vehicle ahead of the first vehicle along the first planned route having a speed of less than the expected speed of the first vehicle at that location; and
computer usable program code for generating an alert message or audio at the second vehicle in response to receiving the electronic alert signal at the second vehicle.

16. The computer program product of claim 1, further comprising:
computer usable program code for automatically generating an expected arrival time of the first vehicle, prior to identifying the proximity of the second vehicle; and
computer usable program code for automatically generating an adjusted arrival time based on identifying the shared segment and the speed of the second vehicle.

17. The computer program product of claim 16, further comprising:
computer usable program code for automatically communicating the adjusted arrival time to an input/output device at a location remote from the first vehicle.

18. The computer program product of claim 1, wherein one or both of the first and second planned routes comprise an electronic map on a GPS-enabled device.
